(19) United States
(12) Patent Application Publication
(10) Pub. No.: US 2006/0099374 A1
(43) Pub. Date: May 11, 2006

(54) Composite masking tape and method of using same

(75) Inventor: Dan Dureiko, Cleveland Heights, OH (US)

Correspondence Address: Thomas E. Young, Esq.;Fay, Sharpe, Fagan, Minnich & McKee, LLP, Seventh Floor, 1100 Superior Avenue, Cleveland, OH, 44114-2579, US

(73) Assignee: Henkel Consumer Adhesives, Inc.

(21) Appl. No.: 11/263,042

(22) Filed: Oct. 31, 2005

Related U.S. Application Data
(60) Provisional application No. 60/649,723, filed on Feb. 3, 2005.
(60) Provisional application No. 60/626,035, filed on Nov. 8, 2004.

(51) Int. Cl. G09F 3/00; B32B 37/00; B32B 7/12

(52) U.S. Cl. 428/43; 156/247; 428/354

(57) ABSTRACT

A composite masking tape having a, masking tape portion and an alignment tape portion. The alignment tape portion has opposing alignment edges that extend outwardly beyond corresponding masking edges of the masking tape portion forming longitudinally extending lateral overhangs. A method of using the composite masking tape is also disclosed.

This application claims priority from U.S. Provisional Patent Application No. 60/649,723 filed on Feb. 3, 2005 and U.S. Provisional Patent Application No. 60/626,035 filed on Nov. 8, 2004, both of which are hereby incorporated herein by reference in their entirety.

### BACKGROUND

The present novel concept broadly relates to the art of adhesive tape products and, more particularly, to a composite masking tape suitable for uniform application along a wall structure and a method of using the same.

The subject composite tape and method are well suited for uniformly masking a portion of a wall adjacent a feature formed therealong prior to the application of a treatment along the feature. One example of a suitable application includes applying the composite tape uniformly along two walls prior to laying a bead of caulk along a seam or joint formed therebetween, and the subject composite tape and method will be discussed in detail with particular reference thereto. However, it is to be distinctly understood that the subject composite tape and method are capable of broad use and that the discussion of this or other specific applications is merely exemplary and not intended to be in any way limiting.

Masking products, generally, are well know and commonly used in a wide variety of applications to mask an area prior to treatment, such as by painting or caulking. Applying a mask to an area prior to treatment of the remaining unmasked area is intended to prevent or at least minimize the inadvertent treatment of the area that is masked. Simply stated, the intended result is to cover the areas that are not to be treated. In practice, however, the achievement of this result is often difficult and time consuming. It is also desirable for the masking product be removable without undesirably affecting the masked area or the treated area adjacent thereto. Additionally, it is desirable for the masking material to be of a relatively low cost because the material itself, once applied to the area, typically becomes at least partially treated and is therefore not normally reusable.

One example of a masking product that is particularly well suited for such applications is single-layer masking tape formed from paper and having an adhesive disposed along one side. This type of product is of relatively low-cost and is, therefore, disposable. Additionally, such a product is typically easily removed from the masked area without undesirably affecting the same. One disadvantage of using a single-layer masking tape, however, is that the same can be difficult to apply uniformly, such as in a straight line, without a guide, such as an adjacent wall of a corner. For example, where a joint between two walls is to be caulked, such as in a bathtub surround or shower, for example, the masking tape is applied adjacent the joint without actually covering the same with the tape. Thus, the masking tape is normally applied in a freehand manner that can undesirably result in an unmasked treatment area that is not uniform, such as having uneven spacing and/or edges that are not straight.

One masking product that has been developed in an effort to overcome this difficulty is shown in U.S. Pat. No. 5,658,632 to Krabill. The '632 patent illustrates a masking tape that has perforations extending longitudinally therealong. The intention is to apply a single length of tape along the joint that is to be treated such that both sides thereof are masked. Then, the central portions can be torn away exposing the area that is to be treated while leaving a relatively uniform mask along the adjacent sides of the joint. There are numerous disadvantages to the product in Krabill, however. One such disadvantage is that the tape itself is still often applied without any sort of guide and in a generally freehand manner. Therefore, there are often portions of the tape that are not uniform or straight. Thus, the resulting unmasked space, while having a more consistent width, remains undesirably formed or applied along the feature. Another disadvantage is that tearing the central portions of the masking tape typically results in frayed paper from the perforations that extend inwardly toward the area to be treated. As such, the fraying can result in a non-uniform edge and, in caulking applications, the frayed paper can become embedded in the caulk. This can make removal of the masking product more difficult and can, in some cases, undesirably affect the appearance of the associated bead of caulk.

### BRIEF DESCRIPTION

A composite masking tape in accordance with one embodiment of the present novel concept is provided and includes a first length of tape having opposing first and second sides and a first width defined between first and second longitudinally extending edges thereof. A first adhesive layer is deposited along the first side of the first length of tape. A second length of tape has opposing first and second sides and a second width defined between first and second longitudinally extending edges thereof. The second length of tape is disposed longitudinally along the first length of tape with the first side of the second length of tape adjacent the second side of the first length of tape. The second width is greater than the first width such that the first and second edges of the second length of tape respectively extend laterally outwardly beyond the first and second edges of the first length of tape. A second adhesive layer is disposed between the first and second lengths of tape such that the lengths of tape are secured to one another.

Another embodiment of a composite tape in accordance with the present novel concept is provided and includes a first length of tape having first and second sides and a first substantially uniform width. A second length of tape has first and second sides and a second substantially uniform width that is greater than the first width. A first adhesive layer is disposed along the first side of the first length of tape. A second adhesive layer is disposed along one of the second side of the first length of tape and the first side of the second length of tape. The second length of tape is disposed longitudinally along the first length of tape with the first side of the second length of tape adjacent the second side of the first length of tape such that the second length of tape forms opposing first and second longitudinally extending lateral overhangs with the first overhang having a greater lateral dimension than the second overhang.

A method of uniformly masking an associated wall feature formed between associated first and second wall portions, in accordance with the present novel concept, is provided and includes a step of providing a first length of composite masking tape. The first length of tape has a masking tape portion and an alignment tape portion extending longitudinally adjacent one another. The masking tape portion has a first adhesive layer disposed along a first side. A second adhesive layer is disposed opposite the first adhesive layer between the masking and alignment tape portions. The alignment tape portion has a greater width than the masking tape portion such that opposing alignment edges of the alignment tape portion extend laterally outwardly from the masking tape portion. Another step includes applying the first length of tape along the associated first wall portion adjacent the associated wall feature such that one of the alignment edges thereof is in substantial, alignment along the associated second wall portion. A further step includes removing the alignment tape portion from the first length of tape.

Another method of applying a length of masking tape uniformly along an associated wall feature formed between associated first and second wall portions, in accordance with the present novel concept, is provided and includes a step of providing a length of composite tape that includes a masking tape portion having a first adhesive layer deposited along a first side thereof and an alignment tape portion extending longitudinally along a second side of the masking tape portion with a second adhesive layer deposited between the masking tape portion and the alignment tape portion. The alignment tape portion having first and second alignment edges extending respectively laterally outwardly beyond first and second masking edges of the masking tape portion. The first alignment edge extends beyond the first masking edge a first distance, and the second alignment edge extends beyond the second masking edge a second distance that is different from the first distance. Another step includes selecting one of the first distance and the second distance for use along the associated wall feature. Still another step includes orienting the length of composite tape along the associated first wall portion adjacent the associated wall feature such that an alignment edge associated with the selected one of the first and second distances is adjacent the associated second wall portion. Still another step includes applying the length of composite tape along the associated first wall portion adjacent the associated wall feature with the selected alignment edge aligned along the associated second wall portion. A further step includes removing the alignment tape portion from along the masking portion such that the masking portion remains in place adjacent the associated wall feature.

### BRIEF DESCRIPTION OF THE DRAWINGS

FIG. 1 is an end view of one embodiment of a composite masking tape in accordance with the present novel concept.

FIG. 2 is an end view of another embodiment of a composite masking tape in accordance with the present novel concept.

FIG. 3 is an end view of still another embodiment of a composite masking tape in accordance with the present novel concept.

FIG. 4 is an end view of a further embodiment of a composite masking tape in accordance with the present novel concept.

FIG. 5 is an end view of still a further embodiment of a composite masking tape in accordance with the present novel concept.

FIGS. 6-9 illustrate one exemplary use of a composite masking tape in accordance with the present novel concept, such as the embodiment in FIG. 1, applied along an associated wall feature formed on an associated wall structure.

FIGS. 10-13 illustrate another exemplary use of a composite masking tape in accordance with the present novel concept, such as the embodiment in FIGS. 2-5, applied along an associated wall feature formed on an associated wall structure.

FIG. 14 is a flow chart illustrating one method of using a composite masking tape in accordance with the present novel concept.

FIG. 15 is a flow chart illustrating further optional steps of the method shown in FIG. 14.

### DETAILED DESCRIPTION

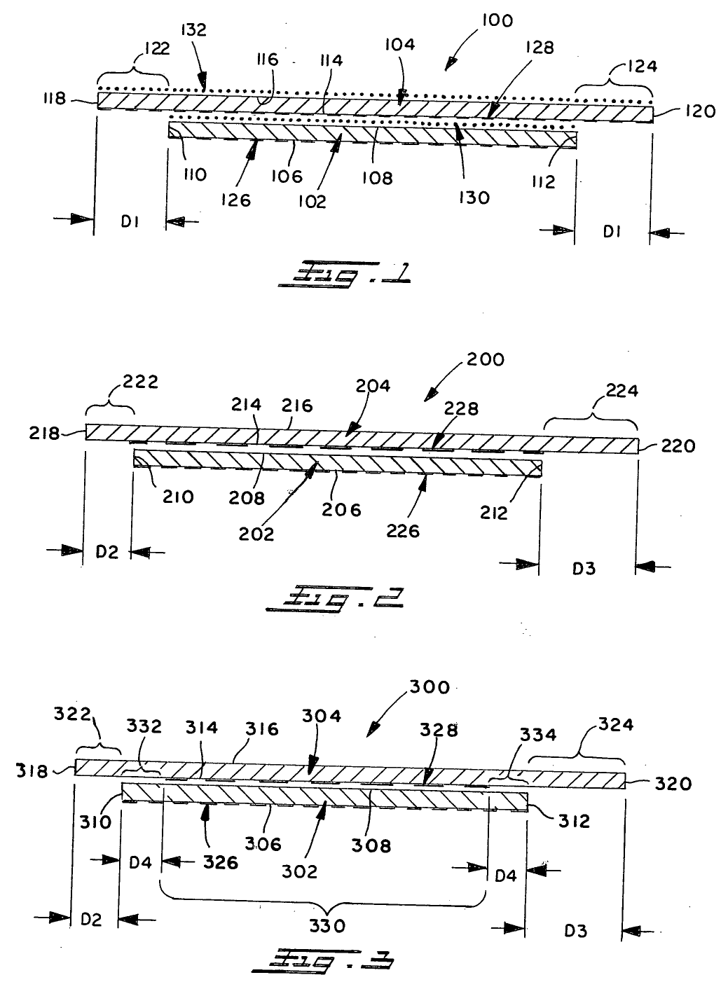

Turning now to the drawings wherein the showings are for the purposes of illustrating exemplary embodiments of the present novel concept only and not for limiting the same, FIG. 1 illustrates a composite masking tape 100 having a bottom or masking tape portion 102 and an upper or alignment tape portion 104. Masking tape portion 102 is shown in FIG. 1 as being substantially planar and having a width dimension that is substantially greater than its thickness dimension. Masking tape portion 102 has a bottom surface or side 106 and an opposing top surface or side 108. Sides 106 and 108 of masking tape portion 102 extend between opposing masking edges 110 and 112. Alignment tape portion 104 is also shown as being substantially planar in FIG. 1 and also includes a bottom surface or side 114 and an opposing top surface or side 116. Alignment tape portion 104 extends laterally between opposing edges 118 and 120, and also has a width dimension that is substantially greater than its thickness dimension. It will be appreciated that composite tape 100, including portions 102 and 104 thereof, generally takes the form of an elongated length of material having a length dimension that is significantly greater than the width dimensions thereof.

Alignment tape portion 104 is oriented along masking tape portion 102 such that top surface 108 of the masking tape portion and bottom surface 114 of the alignment tape portion are adjacent one another. It is clear from FIG. 1 that alignment tape portion 104 has a greater width between edges 118 and 120 than does masking tape portion 102 between edges 110 and 112. As such, longitudinally extending lateral overhangs 122 and 124 are respectively formed outwardly of edges 110 and 112 of the masking tape portion. As shown in FIG. 1, overhangs 122 and 124 are of a substantially equal width dimension D1, and it will be appreciated that the overhangs extend longitudinally along length of tape 100. One example of a suitable size range for width dimension D1 is from about ⅛ of an inch to about 1 inch, though it will be understood that any suitable width dimension can be used and that the foregoing range is merely exemplary.

A first adhesive layer 126 is deposited or otherwise disposed along bottom surface 106 of masking tape portion 102. In one exemplary embodiment, first adhesive layer 126 is disposed evenly both longitudinally and laterally along bottom surface 106. In other exemplary embodiments, however, the adhesive layer can optionally be patterned or zone coated. A second adhesive layer 128 is shown in the exemplary embodiment in FIG. 1 as being disposed along bottom surface 114 of alignment tape portion 104, and in one exemplary embodiment is disposed evenly both longitudinally and laterally along bottom surface 114. However, in alternate embodiments, the second adhesive layer can optionally be patterned or zone coated. Adhesive layers 126 and 128 are indicated in FIG. 1 by substantially similar dashed lines suggesting that, at least in one exemplary embodiment, the same or substantially similar adhesive material can be used. In such an arrangement a suitable release coating 130 can optionally be provided opposite second adhesive layer 128, such as along top surface 128, for example, to facilitate the separation of the masking and alignment tape portions during use. Suitable release coatings can be of any type or kind, and can be deposited or applied in any suitable manner.

Furthermore, a suitable release coating 132 can optionally be provided on top surface 116 of alignment tape portion 104. It will be appreciated that release coating 132 can be of the same or a different type or kind than coating 130 discussed above, and can be deposited or applied in any suitable manner. Release coating 132 may find particular utility where composite masking tape 100 is packaged in roll form. In which case, first adhesive layer 126 will be in contact with top surface 116 of the underlying wraps of the roll, and coating 132 will minimize the adhesion of layer 126 thereto. Also, it will be appreciated that in other arrangements adhesive layer 128 and coating 130, if provided, could, in the alternative, be deposited or otherwise disposed in an inverted arrangement (i.e., along surfaces of the opposing tape portions) without departing from the principles of the present novel concept.

Another exemplary embodiment of a composite masking tape 200 is shown in FIG. 2 and includes a bottom or masking tape portion 202 and an upper or alignment tape portion 204. Masking tape portion 202 includes a bottom surface or side 206 and a top surface or side 208 that extend between opposing outer edges 210 and 212. Similarly, alignment tape portion 204 includes a bottom surface or side 214 and a top surface or side 216 extending between opposing outer edges 218 and 220.

Alignment tape portion 204 is disposed longitudinally along masking tape portion 202 such that top surface 208 of the masking tape portion is adjacent bottom surface 214 of the alignment tape portion. Additionally, it is clear from FIG. 2 that alignment tape portion 204 has a greater width than masking tape portion 202. As such, a longitudinally extending lateral overhang 222 is formed between edges 210 and 218, and a longitudinally extending lateral overhang 224 is formed opposite overhang 222 between edges 212 and 220. Overhang 222 is shown in FIG. 2 as having a dimension D2 that is less than a corresponding dimension D3 of overhang 224. Thus, the overhangs can be of equal width as indicated by dimension D1 in FIG. 1 or, alternately, can have different widths as indicated by dimensions D2 and D3 shown in FIG. 2. One exemplary range for width dimension D2 is from about ⅛ of an inch to about ¾ of an inch. Additionally, a corresponding exemplary range for dimension D3 is from about ¼ of an inch to about 1 inch. However, it will be appreciated that the foregoing ranges are merely examples of suitable ranges and that any suitable widths or dimensions can be used. Furthermore, it will be understood that the composite tape is formed from elongated lengths of material having a longitudinal dimension significantly greater than the corresponding width dimensions of the composite tape.

A first adhesive layer 226 is deposited or otherwise disposed along bottom surface 206 of masking tape portion 202. In one exemplary embodiment, the first adhesive layer extends substantially uniformly along and across bottom surface 206. In other exemplary embodiments, however, a patterned or zone coated adhesive layer can optionally be formed. A second adhesive layer 228 is disposed between tape portions 202 and 204. It will be appreciated that second adhesive layer 228 can be deposited or otherwise disposed along either or both of surfaces 208 and 214, respectively, of tape portions 202 and 204. The second adhesive layer can be disposed either substantially uniformly along and across the corresponding surface, or alternately can be patterned, zone coated or otherwise applied in a discontinuous manner. Additionally, second adhesive layer 228 is shown in FIG. 2 as extending between overhangs 222 and 224 but without including adhesive along these portions. Furthermore, adhesive layers 226 and 228 are indicated in FIG. 2 by dashed lines of two different line weights suggesting that, at least in one exemplary embodiment, adhesive materials of differing strengths or tenacity can be used. For example, adhesive layer 226 could have a higher strength or tenacity and adhesive layer 228 could have a lower relative strength or tenacity. In such an arrangement, the optional release coatings discussed above may not be included.

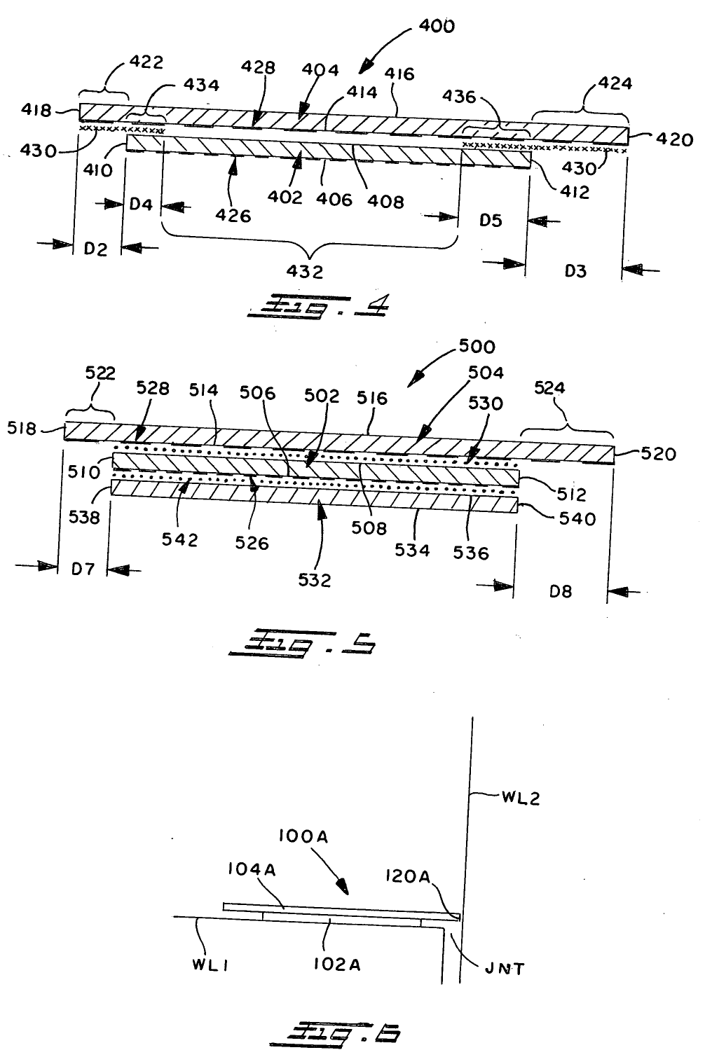

Still another embodiment of a composite masking tape 300 is shown in FIG. 3 and includes a bottom or masking tape portion 302 and an upper or alignment tape portion 304. Masking tape portion 302 includes a bottom:'surface or side 306 and a top surface or side 308 that extend between opposing outer edges 310 and 312. Similarly, alignment tape portion 304 includes a bottom surface or side 314 and a top surface or side 316 extending between opposing outer edges 318 and 320.

Alignment tape portion 304 is disposed longitudinally along masking tape portion 302 such that top surface 308 of the masking tape portion is adjacent bottom surface 314 of the alignment tape portion, which has a greater width than the masking tape portion. Longitudinally extending lateral overhang 322 is formed between edges 310 and 318, and longitudinally extending lateral overhang 324 is formed opposite overhang 322 between edges 312 and 320.

Similar to the embodiment shown in FIG. 2, overhang 322 is shown in FIG. 3 as having a dimension D2 that is less than a dimension D3 of overhang 324. Alternately, the overhangs can be of equal width as indicated by dimensions D1 in FIG. 1. One exemplary range for width dimension D2 is from about ⅛ of an inch to about ¾ of an inch. Additionally, a corresponding exemplary range for dimension D3 is from about ¼ of an inch to about 1 inch. However, it will be appreciated that the foregoing ranges are merely examples of suitable ranges and that any suitable widths or dimensions can be used.

Composite masking tape 300 also includes a first adhesive layer 326 deposited or otherwise disposed along bottom surface 306 of masking tape portion 302. In one exemplary embodiment, the adhesive layer extends substantially uniformly along and across bottom surface 306. In other embodiments, however, a patterned, zone coated or other discontinuous adhesive layer can optionally be used. A second adhesive layer 328 is disposed between tape portions 302 and 304. It will be appreciated that second adhesive layer 328 can be deposited or otherwise disposed along either or both of surfaces 308 and 314, respectively, of tape portions 302 and 304. Rather than extending between edges 310 and 312, second adhesive layer 328 is disposed inwardly of the edges forming a securement area 330 between respective adhesive relief areas 332 and 334 disposed therealong. In the embodiment shown in FIG. 3, adhesive relief areas 332 and 334 are of substantially equal width as indicated by dimensions D4. Alternately, the adhesive relief areas could be of different widths. One example of a suitable range of sizes for dimension D4 is from about 1/16 of an inch to about ½ of an inch. It will be appreciated, however, that the adhesive relief areas can be of any suitable size, shape and/or configuration without departing from the principles of the present novel concept, and that the foregoing range is merely exemplary.

One advantage of providing an adhesive relief area, such as one or both of relief areas 332 and 334, for example, is that such areas help to prevent the inadvertent lifting of the longitudinal edges of the associated masking tape portion. That is, during application of the composite masking tape the masking tape portion is securely applied along the associated wall or surface that is to be masked. This results in a smooth transition between the masked and unmasked areas along which the treatment can be applied. If, however, during removal of the alignment tape portion, the longitudinally extending edges of the masking layer, such as edges 310 and 312 of masking tape portion 302, for example, are lifted or peeled away from the associated wall or surface, an undesirable transition between the masked and unmasked areas could result. By providing adhesive relief areas, such as areas 332 and 334, for example, this lifting or peel away of the masking tape portion can be minimized or avoided.

Yet another embodiment of a composite masking tape 400 is shown in FIG. 4 and includes a masking tape portion 402 and an alignment tape portion 404. As discussed above, masking tape portion 402 includes a bottom surface or side 406, a top surface or side 408 and opposing outer edges 410 and 412. Alignment tape portion 404 likewise includes a bottom surface or side 414, a top surface or side 416 and opposing outer edges 418 and 420. Alignment tape portion 404 is disposed longitudinally along masking tape portion 402 such that top surface 408 and bottom surface 414 are adjacent one another. Additionally, alignment tape portion 404 has a greater width than masking tape portion 402 and longitudinally extending lateral overhangs 422 and 424 are formed therebetween, as have been discussed above, for example. A first adhesive layer 426 is disposed along bottom surface 406 of masking tape portion 402. A second adhesive layer 428 is deposited or otherwise disposed between top surface 408 and bottom surface 414 of tape portions 402 and 404, respectively. Adhesive layers 426 and 428 are shown using different weight lines indicating that adhesives of different strength or tenacity can be used, as discussed above. Additionally, adhesive layers 426 and 428 can be substantially uniform in the lateral and longitudinal directions or can be patterned, zone applied or otherwise formed in a discontinuous manner, as discussed above.

Composite masking tape 400 differs from composite masking tape 300 discussed above with regard to FIG. 3 in that second adhesive layer 428 extends substantially across the width of alignment tape portion 404 rather than stopping inboard of the outer edges of the masking tape portion. Rather than using zone application of the adhesive, which can create difficulties during assembly, a deadening compound 430 is applied longitudinally along portions of adhesive layer 428 to form a securement area 432 and adhesive relief areas 434 and 436. Additionally, adhesive relief areas 434 and 436 are shown in FIG. 4 as having different widths, as indicated by dimensions D5 and D6. One example of a suitable range of sizes for dimension D5 is from about 1/16 of an inch to about ½ of an inch, and one example of a suitable range of sizes for dimension D6 is from about ⅛ of an inch to about ¾ of an inch. It will be appreciated, however, that the adhesive relief areas can be of any suitable size, shape and/or configuration without departing from the principles of the present novel concept, and that the foregoing range is merely exemplary. Additionally, it will be appreciated that dimensions of substantially equal width, such as dimensions D4 in FIG. 3, for example, can alternately be used.

One advantage of using a deadening compound to form the adhesive relief areas is that the compound can be applied at or during assembly of the masking and alignment tape portions. This helps minimize any potential indexing, registration or alignment issues that may be associated with trying to establish and maintain a relationship between tape portions that include earlier applied coatings or layers.

A further embodiment of a composite masking tape 500 is shown in FIG. 5 and includes a masking tape portion 502 and an alignment tape portion 504. Masking tape portion 502 includes a bottom surface or side 506 and a top surface or side 508 that extend between opposing outer edges 510 and 512. Alignment tape portion 504 also includes a bottom surface or side 514 and a top surface or side 516 that extend between opposing outer edges 518 and 520.

It will be appreciated that the masking and alignment tape portions are arranged in a manner that is substantially similar to that shown in and described with regard to the composite masking tapes shown and discussed herein with regard to FIGS. 2-4. More specifically, alignment tape portion 504 is disposed longitudinally along masking tape portion 502 such that top surface 508 of the masking tape portion is adjacent bottom surface 514 of the alignment tape portion. Alignment tape portion 504 has a greater width than masking tape portion 502. As such, alignment portion 504 forms opposing lateral overhangs 522 and 524 that extend longitudinally along masking portion 502. Overhangs 522 and 524 are shown as having dimensions D7 and D8, which are, in one exemplary embodiment, substantially similar to dimensions D2 and D3 described above with regard to the composite masking tapes shown in FIGS. 2-4. It will be appreciated, however, that overhangs 522 and 524 could alternately have equal widths, such as is indicated by dimension D1 of tape 100 shown in FIG. 1.

Additionally, composite masking tape 500 includes a first adhesive layer 526 disposed along bottom surface 506 of masking tape portion 502, and a second adhesive layer 528 disposed along bottom surface 514 of alignment tape portion 504. In one exemplary embodiment, the first adhesive layer has a greater strength or tenacity than the second adhesive layer, as suggested by the different line weights shown in FIG. 5. Alternately, the first and second adhesive layers can be of substantially the same strength or tenacity, and a release coating 530 or other suitable surface condition can optionally be provided along the second adhesive layer to provide a similar release condition.

Furthermore, to prevent first adhesive layer 526 from inadvertently becoming attached to other surfaces, composite masking tape 500 also includes an optional releasable liner 532 disposed longitudinally along masking tape portion 502. Liner 532 has a bottom surface or side 534 and a top surface or side 536 extending between opposing edges 538 and 540. Liner 532 is positioned along masking tape portion 502, such that top surface 536 is adjacent bottom surface 506, and is secured along adhesive layer 526. In the exemplary embodiment shown in FIG. 5, a release coating 542 is provided along top surface 536 and permits the liner to be easily removed from the masking tape portion without undesirably affecting the first adhesive layer. However, it is to be understood that a release liner of any type or configuration could alternately be used. Additionally, liner 532 is shown in FIG. 5 as having about the same width as masking tape layer 502. However, it will be appreciated that a liner of equal or greater width than that of the adhesive layer on the masking portion can be used.

The release liner acts to prevent the first adhesive layer from being inadvertently secured onto a surface prior to use. For example, masking products are commonly packaged in roll form. As such, the first adhesive layer is normally adjacent the underlying wrap of material on the roll. By including the releasable liner, the first adhesive layer does not directly contact the underlying wrap of material and, as such, does not inadvertently adhere to the exposed surface of the wrap. An alternate construction is shown in FIG. 1, in which alignment tape portion 104 of composite masking tape 100 includes a release coating 132 disposed on top surface 116. Since the top surface forms the underlying wrap of material when stored in roll form, release coating 132 acts to prevent the inadvertent adhesion of the first adhesive layer to the underlying top surface. One advantage associated with the use of a release liner, such as liner 532, for example, is that once unrolled, the liner continues to prevent the unintentional attachment of the first adhesive layer to other associated surfaces, as well as to itself, until the liner is actually removed.

In the foregoing exemplary embodiments, the masking and alignment tape portions are preferably secured to one another using a second adhesive layer, such as one of layers 128, 228, 328, 428 and 528, for example, having an at least slightly lesser strength or tenacity than that associated with a first adhesive layer, such as one of layers 126, 226, 326, 426 and 526, for example. This can be achieved in any suitable manner, such as by using a first adhesive compound to form the first layer that has greater adhesive properties than a second, different adhesive compound that is used for the second layer. As another example, the adhesive compound of the first adhesive layer can have substantially the same adhesive properties as that of the second adhesive layer, and a suitable coating or pre-coated material, such as one or more of release coatings 130, 132, 530 and/or 542, for example, can be used in association with the adhesive layers to facilitate the release of the adhesive bond, as will be discussed in detail hereinafter. As a further example, the same or similar adhesive compounds could be used to form the first and second adhesive layers with the first layer being formed form a full, uniform coating of adhesive compound and the second layer being formed from a patterned, zone applied or otherwise discontinuous coating of adhesive compound having areas of substantially uncoated material. It will be appreciated that adhesive compounds, such as those suitable for use in forming the adhesive layers described herein, compounds suitable for forming release coatings, such as coatings 130, 132, 530 and/or 542 for example, and deadening compounds, such as compound 430, for example, are well known and commonly used, and that one of skill in the art will be capable of determining the appropriate adhesive compounds, coatings and materials for use depending upon the specifics of each application. Furthermore, it will be appreciated by the skilled artisan that any suitable combination of adhesive strength, release coatings and/or deadening compounds can be used without departing from the principles of the present novel concept.

The foregoing and other exemplary embodiments of a composite masking tape can be formed from any suitable compounds, such as release coatings, deadening compounds and adhesives; materials, such as paper (coated or uncoated), cellulose or fiber (natural or synthetic, coated or uncoated) and/or polymeric materials; and/or any combination of the foregoing and/or other compounds and materials. The adhesive layers discussed can be formed from any suitable adhesive compound or compounds, such as acrylic-based adhesives or natural or synthetic rubber-containing adhesives, for example. Deadening compounds as discussed herein can be formed from any suitable compounds or combination of materials in any form (e.g., liquid, gel, powder), and can be operative to deaden the tack of the adhesive in any suitable manner, such as by covering the adhesive or by chemically changing the adhesive, for example. Exemplary materials for use as a deadening compound include, without limitation, water-based inks and solvent-based inks, for example. The release coating can be formed from any suitable compound or compounds, such as silicone-containing compounds, vinylacetate-containing compounds, acrylic-containing compounds, or any combination thereof, for example.

As one example of a suitable construction, the masking tape portion and the alignment tape portion could each be formed from a suitable paper material, such as wood-pulp paper or rice paper, for example. As another example, both the masking tape portion and the alignment tape portion could be formed from the same or different polymeric materials, such as a vinyl-containing material or a polyolefin-containing material, for example. As a further example, the masking tape portion can be formed from a polymeric material, such as a vinyl-containing material or a polyolefin-containing material, for example, and the alignment tape portion can be formed from a paper material, such as wood-pulp paper coated with a silicone-containing compound, for example. Additionally, an optional release liner can be included opposite the alignment tape portion and the release liner can be formed from a paper material, such as wood-pulp paper coated with a silicone-containing compound, for example, or from a polymeric material, such as a polyolefin-containing material or a vinyl-containing material, for example. As such, it is to be understood that any suitable materials or combination of materials can be used without departing from the principles of the present novel concept. It will also be appreciated that the tape portions shown in the drawings are not to scale and are shown with an increased thickness dimension for clarity and ease of illustration.

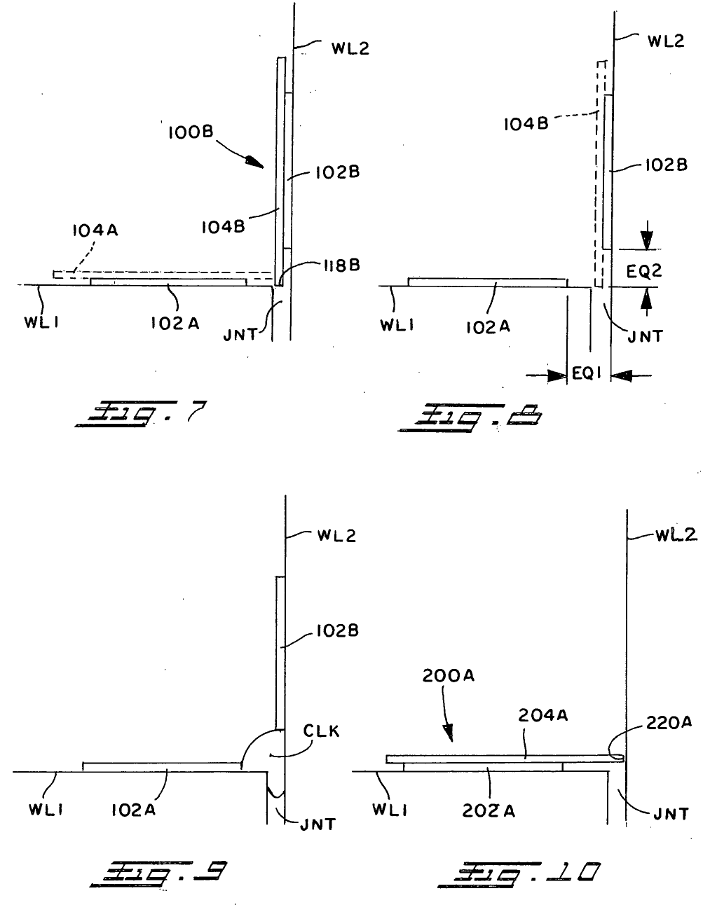

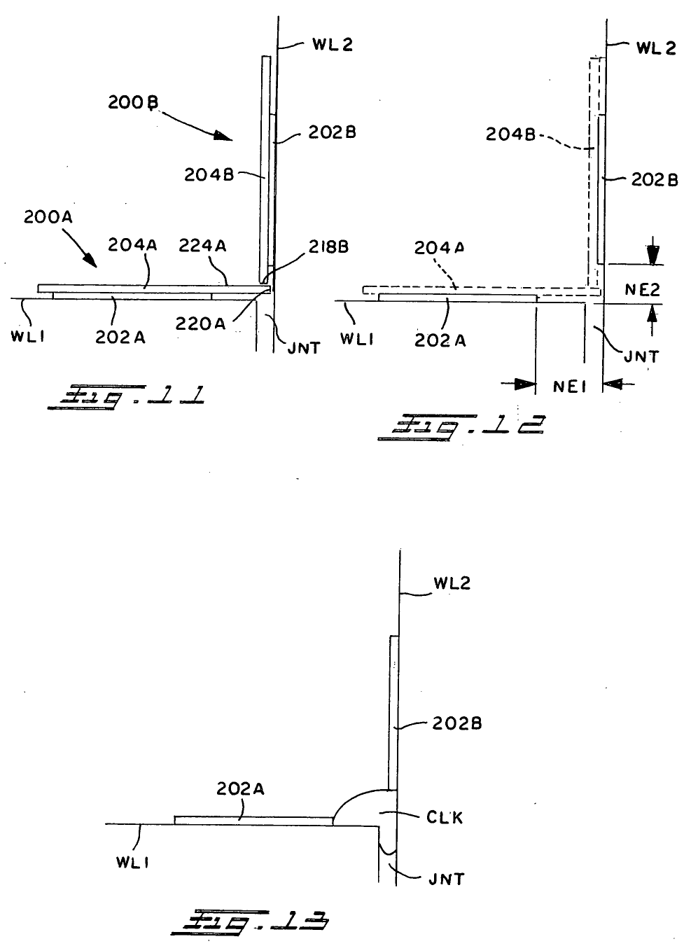

FIGS. 6-9 illustrate an exemplary use of two lengths of one embodiment of a composite masking tape, such as composite masking tape 100, for example, along an associated wall feature, such as a joint JNT, for example, formed between associated wall structures or wall portions, such as an associated first wall WL1 and an associated second wall WL2, for example. In FIG. 6, a first length of masking tape 100A is applied on wall WL1 adjacent joint JNT with masking tape portion 102A secured along the wall by the first adhesive layer (not shown) and edge 120A of alignment tape portion 104A suitably aligned along wall WL2. In FIG. 7, alignment tape portion 104A has been removed leaving masking tape portion 102A secured along wall WL1. A second length of composite masking tape 100B is applied along wall WL2 adjacent joint JNT. Masking tape portion 102B is secured by the first adhesive layer (not shown) on wall WL2 with edge 118B of alignment tape portion 104B extending along joint JNT in suitable alignment with wall WL1. In FIG. 8, alignment tape portion 104B is shown as being removed to expose masking tape portion 102B secured along wall WL2. This provides a uniformly masked area extending along joint JNT with dimensions EQ1 and EQ2, which are shown in FIG. 8 as being approximately equal. A treatment, such as the application of a bead of caulk CLK, for example, is applied or otherwise performed along joint JNT while masking tape portions 102A and 102B are in place, as shown in FIG. 9. It will be appreciated that, in practice, some amount of the treatment or treatment material, such as caulk CLK, for example, will typically overflow along one or both of the masking tape portions. Thereafter, the masking tape portions can be removed leaving a substantially uniformly treated area.

FIGS. 10-13 illustrate an exemplary use of two lengths of another exemplary composite masking tape along an associated wall feature, such as an associated joint JNT, for example, formed along or between associated wall structures or wall portions, such as first and second walls WL1 and WL2, for example. Composite masking tape 200 is shown in use in FIGS. 10-13. However, it will be appreciated that this showing is merely exemplary and that other embodiments, such as composite masking tapes 300, 400 or 500, for example, could have alternately been used.

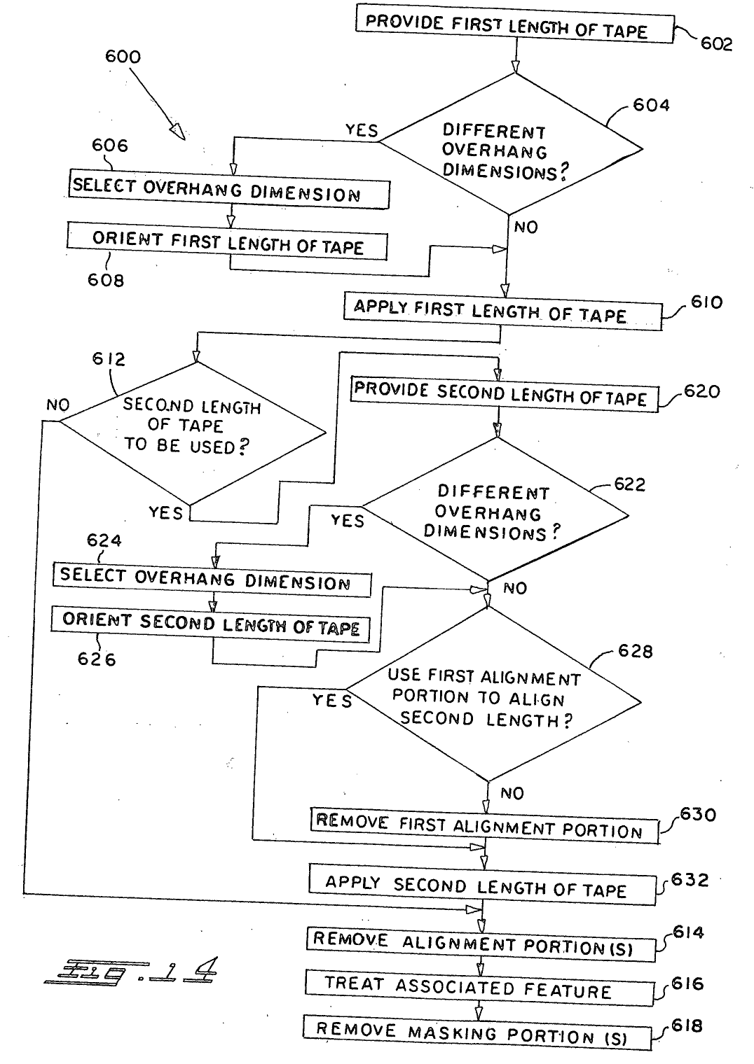

In FIG. 10, a length of composite masking tape 200A is disposed longitudinally along joint JNT. Masking tape portion 202A is secured on wall WL1 by the first adhesive layer (not shown) such that edge 220A of alignment tape portion 204A is suitably aligned along wall WL2. In FIG. 11, a second length of composite masking tape 200B is secured on wall WL2 by the first adhesive layer (not shown) of masking tape portion 202B. As is clear from FIG. 11, alignment tape portion 204A of the first length of composite masking tape 200A is not removed from masking tape portion 202A prior to applying the second length of composite masking tape, as was described in the earlier arrangement. As such, edge 218B of alignment tape portion 204B can be substantially aligned along overhang 224A of alignment tape portion 204A rather than along wall WL1, as was described above.

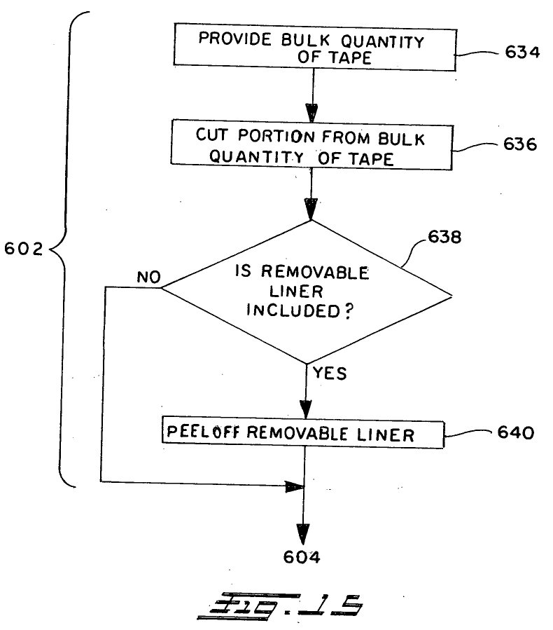

As shown in FIG. 12, alignment portions 204A and 204B are thereafter removed to expose masking portions 202A and 202B, respectively. Thus, a substantially uniformly masked area extending longitudinally along joint JNT is formed. Due to the use of lengths of composite masking tape having two different overhangs, the uniformly masked area extends along walls WL1 and WL2 in amounts that are non-equal, as indicated by dimensions NE1 and NE2. As shown in FIG. 13, a treatment, such as applying a bead of caulk CLK along joint JNT, for example, can then be completed. At a suitable point after the treatment, masking tape portions 202A and 202B can be removed leaving, according to one exemplary use, a uniform bead of caulk having different dimensions along walls WL1 and WL2.

A method 600 of using a composite masking tape, such as tapes 100, 200, 300, 400 and/or 500, for example, is shown in FIG. 14. Method 600 includes a step 602 of providing a first length of composite masking tape. Embodiments having the same overhang width, such as tape 100, for example, and embodiments having different overhang dimensions, such as tapes 200, 300, 400 and/or 300, for example, are discussed in detail herein. Thus, an inquiry or decision is made in decision step 604 as to whether a product having two different overhang dimensions is available and/or will be used. If a YES decision is reached, then the user selects the desired overhang in step 606 and the first length of tape is, in step 608, suitably oriented along the feature or joint to utilize the desired overhang. Thereafter or, alternately, if a tape product having a single overhang dimension is to be used, the first length of tape can be applied along the feature, as indicated in step 610.

Depending upon the specifics of the application and wall structure, as well as the desired result, the user may choose to apply a second length of composite masking tape. As such, an inquiry is made in decision step 612 as to whether or not a second length of tape will be used. If a NO decision is made, the user proceeds to remove the alignment layer or tape portion from the first length of tape, as indicated in step 614. The associated feature can then be treated, as indicated by step 616, and the masking layer or tape portion can then be removed at a suitable interval, as indicated at step 618.

Should the user determine that a second length of composite masking tape will be used, then a YES decision is reached at decision step 612. As such, a second length of composite masking tape, such as tapes 100, 200 300, 400 and/or 500, for example, is provided in step 620. Regardless of which composite tape construction was used for the first length of masking tape, any of the available constructions can be used in step 620. Accordingly, a determination is again made in decision step 622 as to whether or not a product having two different overhang dimensions is available and will be used. If a YES decision is reached by the user, then a step 624 of selecting the desired overhang dimension and a step 626 of suitably orienting the desired overhang along the feature are completed.

After step 626 or, alternately, if a NO decision is reached at decision step 622 indicating that a tape product having a single overhang dimension is to be used, a determination is made in decision step 628 as to whether the alignment tape portion of the first length of composite tape will be used to align the second length of composite tape along the feature. If a NO decision is made, then the alignment tape portion is removed, as indicated in step 630. After step 630 or, alternately, if a YES determination is made at decision step 628, the second length of composite tape is applied along the associated wall as indicated at step 632, using the appropriate surface or structure for alignment. Thereafter, any remaining alignment layers or tape portions are removed in step 614. The treatment is then applied to or along the associated features in step 616 and the masking portions can then be removed after a suitable interval, as indicated by step 618.

Step 602 discussed above can be accomplished in any suitable manner and can optionally include additional steps, as indicated in FIG. 15. For example, step 602 of providing a first length of tape can include an initial step 634 of providing a bulk quantity of tape. Typically, such a bulk quantity of tape would be provided as a roll or in another suitably convenient form. As another step 636, a portion of the bulk quantity of tape is cut or otherwise separated from the bulk quantity. An additional decision step 638 includes determining whether the bulk quantity and resulting cut length includes a removable liner. If a NO decision is reached, then step 604 of determining whether the tape includes different overhang dimensions is reached and the method steps can proceed as discussed above. If a YES decision is made, a step 640 is reached and includes peeling or otherwise removing the releasable liner, such as liner 532 in FIG. 5, for example, to ready the cut length of tape for proceeding to step 604, as discussed above.

Associated first and second walls WL1 and WL2 as well as associated joint JNT are shown and described herein, and specific reference is made to these features. It is to be distinctly understood, however, that these features are merely exemplary of features in association with which the subject exemplary embodiments of the present novel concept can be used. As such, it will be recognized that the present novel concept is capable of broad use on a wide variety of structural features and elements, such as walls, wall portions, wall sections, structural or ornamental elements or features, doors, windows, joints, seams, corners, edges and/or any other such features, for example, and that the present novel concept is not intended to be limited to use on or with the specific associated structural features shown and described herein.

While the subject novel concept has been described with reference to the foregoing embodiments and considerable emphasis has been placed herein on the structures and structural interrelationships between the component parts of the embodiments disclosed, it will be appreciated that other embodiments can be made and that many changes can be made in the embodiments illustrated and described without departing from the principles of the subject novel concept. Obviously, modifications and alterations will occur to others upon reading and understanding the preceding detailed description. Accordingly, it is to be distinctly understood that the foregoing descriptive matter is to be interpreted merely as illustrative of the present novel concept and not as a limitation. As such, it is intended that the subject novel concept be construed as including all such modifications and alterations insofar as they come within the scope of the appended claims and any equivalents thereof.

1. A composite masking tape comprising:
a first length of tape having opposing first and second sides and a first width defined between first and second longitudinally extending edges;
a first adhesive layer deposited along said first side of said first length of tape;
a second length of tape having opposing first and second sides and a second width defined between first and second longitudinally extending edges, said second length of tape being disposed longitudinally along said first length of tape with said first side of said second length of tape adjacent said second side of said first length of tape, said second width being greater than said first width such that said first and second edges of said second length of tape respectively extend laterally outwardly beyond said first and second edges of said first length of tape; and,
a second adhesive layer disposed between said first and second lengths of tape such that said lengths of tape are secured to one another.

2. A composite masking tape according to claim 1, wherein said first adhesive layer has a greater adhesive strength than said second adhesive layer.

3. A composite masking tape according to claim 1, wherein said first adhesive layer is uniformly dispersed longitudinally and laterally along said first side of said first length of tape.

4. A composite masking tape according to claim 1, wherein said first adhesive layer is dispersed along substantially all of said first side of said first length of tape.

5. A composite masking tape according to claim 1, wherein said second adhesive layer is disposed on one of said second side of said first length of tape and said first side of said second length of tape.

6. A composite masking tape according to claim 5, wherein said second adhesive layer is uniformly dispersed longitudinally and laterally along substantially all of said first side of said second length of tape.

7. A composite masking tape according to claim 1, wherein a portion of said second adhesive layer is treated with a deadening compound.

8. A composite masking tape according to claim 7, wherein said deadening compound includes one of a water-based ink or a solvent-based ink.

9. A composite masking tape according to claim 7, wherein said deadened portion of said adhesive layer extends along at least one of said first and second longitudinally extending edges of said second length of tape.

10. A composite masking tape according to claim 9, wherein said deadened portion extends inwardly beyond a corresponding one of said first and second longitudinally extending edges of said first length of tape.

11. A composite masking tape according to claim 1, wherein at least one of said first length of tape or said second length of tape is formed from one of a paper material or a polymeric material.

12. A composite masking tape according to claim 11, wherein said polymeric material is one of a vinyl-containing or polyolefin-containing material.

13. A composite masking tape according to claim 1, wherein at least one of said first adhesive layer or said second adhesive layer includes at least one of an acrylic-based or a rubber-containing adhesive.

14. A composite masking tape according to claim 1 further comprising a release coating deposited on one of said second side of said first length of tape, said first side of said second length of tape or said second side of said second length of tape.

15. A composite masking tape according to claim 14, wherein said release coating includes at least one of a silicone-containing compound, a vinylacetate-containing compound or an acrylic-containing compound.

16. A composite masking tape according to claim 1 further comprising a release liner disposed along said first adhesive layer opposite said first length of tape.

17. A composite tape comprising:
a first length of tape having first and second sides and a first substantially uniform width;
a second length of tape having first and second sides and a second substantially uniform width that is greater than said first width;
a first adhesive layer disposed along said first side of said first length of tape; and,
a second adhesive layer disposed along one of said second side of said first length of tape and said first side of said second length of tape;
said second length of tape being disposed longitudinally along said first length of tape with said first side of said second length of tape adjacent said second side of said first length of tape such that said second length of tape forms opposing first and second longitudinally extending lateral overhangs with said first overhang having a greater lateral dimension than said second overhang.

18. A composite tape according to claim 17, wherein said first adhesive layer has a greater adhesive strength than said second adhesive layer.

19. A composite tape according to claim 17 further comprising a release coating along one of said second side of said first length of tape or said second side of said second length of tape.

20. A composite masking tape according to claim 17, wherein said second length of tape has opposing longitudinally extending edges, and said second adhesive layer secures said first and second lengths of tape together along a securement area formed inwardly of said opposing longitudinally extending edges.

21. A composite masking tape according to claim 20, wherein said second adhesive layer is deposited only along said securement area.

22. A composite masking tape according to claim 20, wherein said second adhesive layer is disposed laterally outwardly beyond said securement area and at least a portion of said second adhesive layer is deadened to form said securement area.

23. A method of uniformly masking an associated wall feature formed between associated first and second wall portions, said method comprising steps of:
a) providing a first length of composite masking tape having a masking tape portion and an alignment tape portion extending longitudinally adjacent one another, said masking tape portion having a first adhesive layer disposed along a first side, a second adhesive layer is disposed opposite said first adhesive layer between said masking and alignment tape portions, and said alignment tape portion having a greater width than said masking tape portion such that opposing alignment edges of said alignment tape portion extend laterally outwardly from said masking tape portion;
b) applying said first length of tape along the associated first wall portion adjacent the associated wall feature such that one of said alignment edges thereof is in alignment along the associated second wall portion; and,
c) removing said alignment tape portion from said first length of tape.

24. A method according to claim 23 further comprising steps of:
d) providing a second length of tape including a masking tape portion, an alignment tape portion, a first adhesive layer disposed along said masking tape portion and a second adhesive layer disposed between said masking and alignment tape portions, said alignment tape portion including opposing alignment edges; and,
e) applying said second length of tape along the associated second wall portion adjacent the associated wall feature such that one of said alignment edges thereof is in alignment along one of said alignment tape portion of said first length of tape or the associated first wall portion.

25. A method according to claim 24, wherein step c) is performed after step e) and further includes removing said alignment tape portion from said second length of tape.

26. A method of applying a length of masking tape uniformly along a associated wall feature formed between associated first and second wall portions, said method comprising steps of:
a) providing a length of composite tape including a masking tape portion having a first adhesive layer deposited along a first side thereof and an alignment tape portion extending longitudinally along a second side of said masking tape portion with a second adhesive layer deposited between said masking tape portion and said alignment tape portion, said alignment tape portion having first and second alignment edges extending respectively laterally outwardly beyond first and second masking edges of said masking tape portion, said first alignment edge extending beyond said first masking edge a first distance and said second alignment edge extending beyond said second masking edge a second distance that is different from said first distance;
b) selecting one of said first distance and said second distance for use along the associated wall feature;
c) orienting said length of composite tape along the associated first wall portion adjacent the associated wall feature such that an alignment edge associated with said selected one of said first and second distances is adjacent the associated second wall portion;
d) applying said length of composite tape along the associated first wall portion adjacent the associated wall feature with said selected alignment edge aligned along the associated second wall portion;
e) removing said alignment tape portion from along said masking portion such that said masking portion remains in place adjacent the associated wall feature.

27. A method according to claim 26 further comprising steps of:
f) providing a second length of composite tape that includes a second masking tape portion and a second alignment tape portion disposed longitudinally along said second masking tape portion, said second alignment tape portion having first and second longitudinally extending alignment edges; and,
g) applying said second length of composite tape along the associated second wall portion adjacent the associated wall feature with an alignment edge of the second length of tape aligned along one of the associated first wall portion and said alignment tape portion of the first length of tape.

28. A method according to claim 27, wherein said first alignment edge of said second length of tape extends laterally outwardly beyond said masking tape portion of said second length of tape a first distance, said second alignment edge of said second length of tape extends laterally outwardly beyond said masking tape portion of said second length of tape a second distant, and said first distance is greater than said second distance, and said method further comprising steps of selecting one of said first and second distances of said second length of tape, and orienting said second length of tape along the associated second wall portion adjacent the associated wall feature such that an alignment edge associated with said selected one of said first and second distances is adjacent one of the associated first wall portion or said alignment tape portion of said first length of tape.

29. A method according to claim 27, wherein step e) is performed after applying said second length of tape and includes removing said alignment tape portion from said second length of tape.

30. A method according to claim 27 further comprising a step of removing said masking tape portions of said first and second lengths of tape.

31. A method according to claim 27, wherein the associated first wall portion is a section of a first wall, the associated second wall portion is a section of a second wall different from said first wall and extending at an angle thereto, and the associated wall feature is an open joint formed between the first and second walls, said method further comprising orienting said first and second lengths of composite tape at an angle to one another corresponding to said angle between said first and second walls.
